(19) United States
(12) Patent Application Publication
(10) Pub. No.: US 2026/0252490 A1
(43) Pub. Date: Aug. 27, 2026

(54) Prefetcher with Multi-Cache Level Prefetches and Feedback Architecture

(71) Applicant: SiFive, Inc., San Mateo, CA (US)

(72) Inventors: Benoy Alexander, Cedar Park, TX (US); Mohit Gopal Wani, Sunnyvale, CA (US); John Ingalls, San Mateo, CA (US)

(21) Appl. No.: 18/577,363

(22) PCT Filed: Jun. 3, 2022
(86) PCT No.: PCT/US2022/032054

§ 371 Date: Jan. 8, 2024

Related U.S. Application Data
(60) Provisional application No. 63/221,217, filed on Jul. 13, 2021.

(51) Int. Cl. G06F 12/0811; G06F 12/0862

(52) U.S. Cl. CPC G06F 12/0811; G06F 12/0862; G06F 2212/6028

(57) ABSTRACT

Described is a prefetcher with multi-cache level prefetches and feedback architecture. A processing system includes two or more cache levels, each cache level including miss status holding registers, and a prefetcher connected to each of the two or more cache levels The prefetcher configured to receive feedback from the miss status holding registers at each cache level for previously sent prefetches and control number of prefetches sent for a trained entry to each cache level of the two or more cache levels based on the feedback.

### TECHNICAL FIELD

This disclosure relates to a prefetcher.

### BACKGROUND

A prefetcher is used to retrieve data into a cache memory prior to being used by a core, to improve the throughput of the core. The prefetcher performs accesses to memory based on patterns of data accesses or requests made by the core. The data accesses may be specific to a hardware thread of an application executing in the core. For example, if a hardware thread is reading every 64^{th} byte of a large array and the accesses are missing in the level 1 (L1) cache, the prefetcher will detect these misses. Typically, lower level caches can handle more outstanding misses, the prefetcher then allocates the appropriate memory addresses to the level 2 (L2) cache which will cover more of the memory latency since there is more memory level parallelism. This reduces overall access time to the array and improves the performance of the application. The prefetcher can monitor multiple data streams per hardware thread. A data stream consists of a base address and a stride between memory addresses. Prefetches are automatically issued to the memory system when possible.

Prefetchers can work with miss status holding registers (MSHRs), where each MSHR entry tracks a pending cache miss or what data is being requested from higher levels of memory. On a cache miss, the MSHR entries can be checked to see if the same data request is currently pending from prior data requests. For a matching MSHR entry, the data request can be merged into the matching MSHR entry, foregoing a duplicative issue. In the event of no matches, a new MSHR entry and cache line can be reserved for the data request. In a steady state, prefetchers are designed to stay ahead of demand requests so that a demand request hits in the L1 data cache. However, the L1 data cache has a limited number of MSHR entries, making it difficult to meet steady state operating performance.

### SUMMARY

Disclosed herein are methods and devices for a prefetcher with multi-level prefetches and feedback architecture.

In implementations, a processing system includes two or more cache levels, each cache level including miss status holding registers, and a prefetcher connected to each of the two or more cache levels The prefetcher configured to receive feedback from the miss status holding registers at each cache level for previously sent prefetches and control number of prefetches sent for a trained entry to each cache level of the two or more cache levels based on the feedback.

In implementations, a method for sending prefetches includes receiving, by a prefetcher from miss status holding registers at each cache level of a multi-cache level hierarchy, feedback for previously sent prefetches and controlling, by the prefetcher, number of prefetches sent for a trained entry to two or more cache levels in the multi-cache level hierarchy based on the feedback.

In implementations, a prefetcher includes one or more trained entries for each cache in at least a two-level cache hierarchy. The prefetcher configured to receive feedback, from miss status holding registers at each cache of the at least two-level cache hierarchy, for previously sent prefetches and control sending, to two or more caches in the at least two-level cache hierarchy, prefetches for a trained entry based on the feedback.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram showing an example of a microarchitecture for a processing system with a prefetcher.

FIG. 2 is a block diagram showing an example of hardware prefetcher sending L1 and L2 prefetches.

FIG. 3 is a diagram showing an example state machine for a hardware prefetcher.

FIG. 4 is a flowchart of an example method for hardware prefetcher operation in the trained state.

FIG. 5 is a flowchart of an example method for forgiveness for a trained entry in a hardware prefetcher.

FIG. 6 is a block diagram showing an example of feedback in a hardware prefetcher.

### DETAILED DESCRIPTION

Described herein is a prefetcher with multi-level prefetches and feedback architecture. A prefetch is an attempt to obtain predicted data from a specific cache that has not yet been requested. The prefetcher is a hardware prefetcher which enables memory level parallelism and hides memory latency. The hardware prefetcher is a region-based sequential stride prefetcher or a window based prefetcher. For example, in a window based prefetcher, a window is a contiguous memory block having a base address and a stride determined from demand requests such as demand load requests. The base address is the midpoint of the window and the stride is divided between a backward looking direction and a forward looking direction. The base address slides in the window as the demand stream and/or prefetch stream moves through the contiguous memory block. The hardware prefetcher can include multiple entries, where each entry is responsible for a prefetch stream. Each entry has its own window defined by a base address and stride.

The hardware prefetcher trains on pattern detection of demand requests or demand load requests. For example, the hardware prefetcher receives a first L1 demand request having a line address which consists of a region virtual address and a region offset. Note that since the hardware prefetcher is virtual address based, the crossing of page boundaries during a prefetch is not a factor. The hardware prefetcher receives a second L1 demand request and calculates a stride based on the current address (from the second L1 demand request) and the previous address (from the first L1 demand request). The hardware prefetcher receives a third L1 demand request which confirms the stride. The hardware prefetcher can start generating N L1 prefetch requests, where N is the prefetch degree or distance and can be either statically programmed or dynamically adjusted with a programmable maximum cap. Each L1 prefetch request establishes an MSHR and sends an acquisition block request or read request to a downstream cache hierarchy. The hardware prefetcher sends prefetches that either go to L1 MSHRs or L2 MSHRs directly depending on a microarchitectural state of the prefetcher as described herein. In a steady state, hardware prefetcher operation results in hitting in the L1 data cache for each demand load, hitting in the L2 cache for each L1 prefetch, and sending a L1 prefetch and a L2 prefetch for each confirmation of a demand load, where the confirmation is feedback from the L1 MSHR that a hardware prefetcher entry is operating well. The confirmation indicates that a demand load address matches a pending prefetch address.

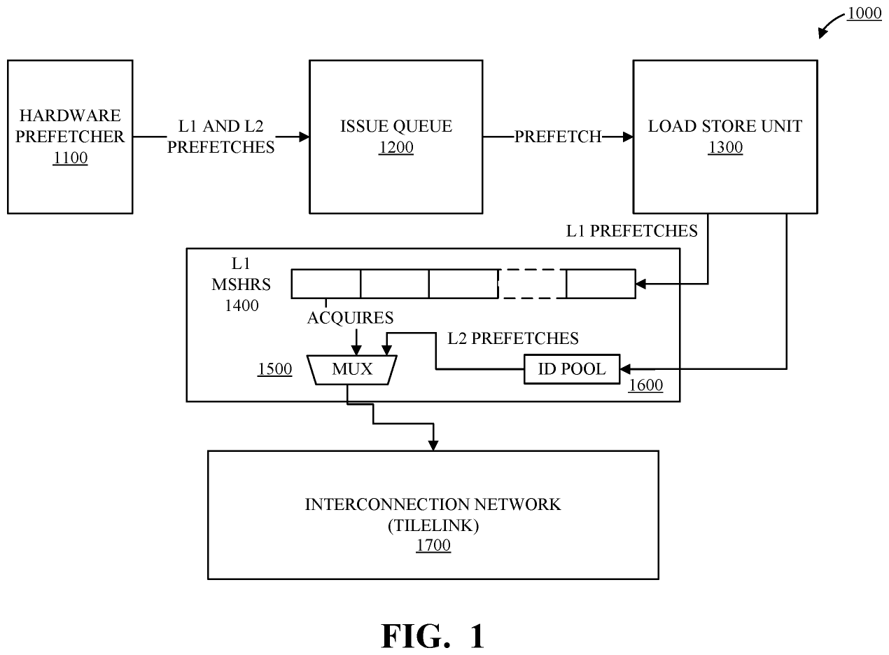

FIG. 1 is a block diagram showing an example of a microarchitecture flow for a processing system 1000. The processing system 1000 can include a hardware prefetcher 1100 connected to or in communication with (collectively “connected to”) a prefetch issue queue 1200, which in turn is connected to a load-store unit 1300. The load store unit 1300 is connected to L1 MSHRs 1400, which in turn is connected to a multiplexor 1500. The load store unit 1300 is further connected to an ID pool 1600, which in turn is connected to the multiplexor 1500. The multiplexor 1500 is connected to an interconnection network 1700, such as but not limited to TileLink, which is connected to downstream cache hierarchy and other components of the processing system 1000 as appropriate and applicable. Although FIG. 1 describes and illustrates ID pool and L2 prefetches, it is applicable and extendable to higher level caches in a cache hierarchy without departing from the scope of the specification or claims.

Operationally, the hardware prefetcher 1100 with a trained entry can send a L1 prefetch and a L2 prefetch to the prefetch issue queue 1200 upon the hardware prefetcher 1100 receiving a confirmation(s) for a demand(s) or demand load(s) from a L1 MSHR entry. That is, the L1 prefetch and the L2 prefetch are generated on-the-fly upon receiving the confirmation in contrast to being pregenerated. As described herein, the hardware prefetcher 1100 can skip sending prefetches when needed to prevent unnecessary transactions. A confirmation is when a prefetch request is later confirmed with a demand access to the same cache line. As described herein, each trained entry in the hardware prefetcher 1100 is trained with respect to the L1 data cache, L2 cache, and higher level caches. The hardware prefetcher 1100 can therefore, for example, send L1 and L2 prefetches for the same trained entry. The issue queue 1200 can send a next prefetch in queue to the load-store unit 1300. The load-store unit 1300 can send the L1 prefetches to the L1 MSHRs 1400, which in turn sends an acquisition request to the downstream cache hierarchy. The load-store unit 1300 can send the L2 prefetches to the ID pool 1600 to obtain access to the interconnection network 1700 so as to continue processing with the downstream cache hierarchy.

The hardware prefetcher 1100 also uses MSHR feedback, which indicates whether prefetches are hitting in any established MSHR entries and whether demands from the load-store unit 1300 or core are hitting in any established MSHR entries. The MSHR feedback can be used by the hardware prefetcher 1100 to control and manage the sending of prefetches. A confirmation is a type of MSHR feedback. Other types of MSHR feedback are described herein.

In implementations, the prefetch issue queue 1200 can be used to replay a prefetch from the prefetch issue queue if MSHRs are exhausted while the prefetch is in the load-store unit 1300 or prior to completion of sending the prefetch, where MSHR fullness or exhaustion is a type of MSHR feedback. In implementations, the prefetch issue queue can enable the prefetcher to replay a prefetch if there is a miss in the page table cache, a miss in view of a resource check, or a miss in view of a hazard check prior to completion of sending the prefetch. For example, if an L1 prefetch is sent out when there is an MSHR available, but while in flight, the available MSHR is taken by another L1 prefetch. In this instance, the hardware prefetcher 1100 can convert the L1 prefetch to an L2 prefetch on-the-fly and/or replay the L1 prefetch from the prefetch issue queue.

In implementations, an issue queue injection or priority request can be used by the hardware prefetcher 1100 to insert a prefetch into the queue. Demands (i.e., loads or stores) have priority over prefetches. Prefetches are nominally used to fill the gaps in the queue. The hardware prefetcher 1100 can send an issue queue injection or priority request for a prefetch to override the normal priority to obtain a slot in the queue.

In implementations, the prefetch issue queue 1200 can have a defined number of slots, a defined number of slots for L1 prefetches, and a defined number of slots for L2 prefetches. The number of slots can vary as between the L1 prefetches and the L2 prefetches.

Ideally, the prefetch stream is ahead of the demand stream so that during steady state hardware prefetcher operation each demand load hits in the L1 data cache and each L1 prefetch hits in the L2 cache. The hardware prefetcher 1100 uses feedback indicating positive reinforcement from the L1 MSHRs, or combinations thereof to increase a prefetch-distance used by the hardware prefetcher 1100, where the prefetch-distance is how far ahead the prefetches are relative to the demand stream. Since there are a limited number of L1 MSHRs in the L1 data cache, the hardware prefetcher 1100 uses both L1 MSHRs and L2 MSHRs to meet the prefetch-distance. The hardware prefetcher 1100 can use different feedback mechanisms to tune which L1 MSHRs and L2 MSHRs to use, throttle sending of specific prefetches, track long streams, track multiple streams, prefetch from multiple streams, and prefetch from multiple levels of a cache hierarchy.

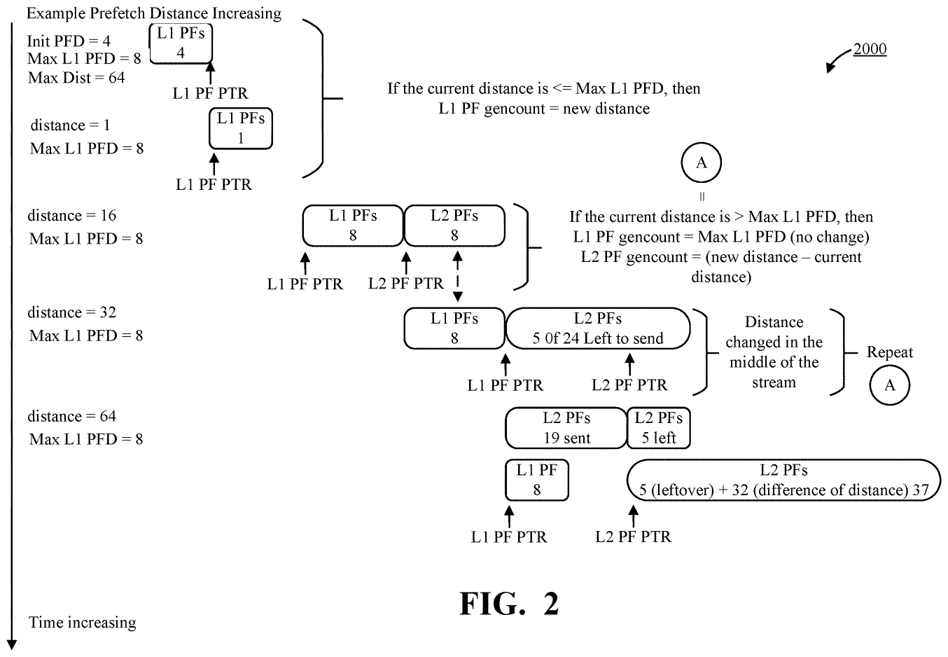

FIG. 2 is a block diagram showing an example flow 2000 of how a hardware prefetcher, such as hardware prefetcher 1100, can send dual L1 and L2 prefetches. The hardware prefetcher can use a L1 prefetch pointer (L1 PF PTR) and a L2 prefetch pointer (L2 PF PTR) to indicate an address of the last L1 prefetch and L2 prefetch sent by the hardware prefetcher, respectively. The hardware prefetcher can also use generate-prefetch counters, a L1 PF gencount and a L2 PF gencount, to indicate how many prefetches ahead each of the respective pointers can be.

In the flow 2000 example, the distance for a trained entry in the hardware prefetcher is being aggressively increased over time as a result of confirmations received by the hardware prefetcher. As illustrated, each of the L1 PF gencount and the L2 PF gencount are updated as the distance is increased over time.

Once an entry in the hardware prefetcher is trained, certain parameters are set to default values using, for example, configuration status registers. In this instance, an initial distance is set to 4, a maximum L1 prefetch-distance is set to 8, and a maximum distance is set to 64.

The hardware prefetcher starts with L1 MSHRs. The L1 PF gencount is set to 4, which is the initial distance. The hardware prefetcher starts generating prefetches from the L1 PF PTR. Relationally, the demand stream is to the left of the L1 PF PTR as a prefetch stream is supposed to be ahead of the demand stream. At this time, the hardware prefetcher is attempting to get 8 prefetches ahead of the demand stream. The L1 PF gencount is decremented as the hardware prefetcher starts generating and sending the L1 prefetches.

As time progresses, the distance (which was initially set to 1), is now set to 16 based on confirmations and MSHR feedback received from L1 MSHRs, L2 MSHRs, or combinations thereof. Consequently, the L1 PF PTR, the L2 PF PTR, the L1 PF gencount, and the L2 PF gencount have to be updated. Remember that there are a limited number of L1 MSHRs (for example 8) and therefore the maximum L1 prefetch-distance is set to 8. The L1 PF gencount is therefore set to 8. However, the distance is set to 16. Therefore, the L2 PF gencount is set to 8 (i.e., new distance (16)-current distance (8)). That is, the hardware prefetcher will now generate 8 L2 prefetches with the L2 PF PTR starting at the L1 PF PTR plus 8 L1 prefetches. As time progresses, the hardware prefetcher pulls or merges the L2 MSHR entries into the L1 MSHRs. This is illustrated by the double ended dashed arrow between rows 3 and 4, where the L1 PF PTR is now at the end of the original L2 prefetches in row 4.

As time progresses, the distance (which was 16), is now set to 32 based on confirmations and MSHR feedback. In this instance, there are no more L1 MSHR entries available. However, there are still L2 MSHR entries available. The L2 PF gencount is therefore set to 24. The hardware prefetcher starts sending the remaining 24 prefetches as L2 prefetches (i.e., 32−8). However, the distance changes to 64 after the hardware prefetcher has sent 19 L2prefetches. The L1 MSHR entries are still not available. Consequently, the L2 PF gencount is set to 37 (5 left+(64−32)).

Sending of dual L1 and L2 prefetches is enabled by the hardware prefetcher using the same state machine to train an entry and send prefetches for or from the entry.

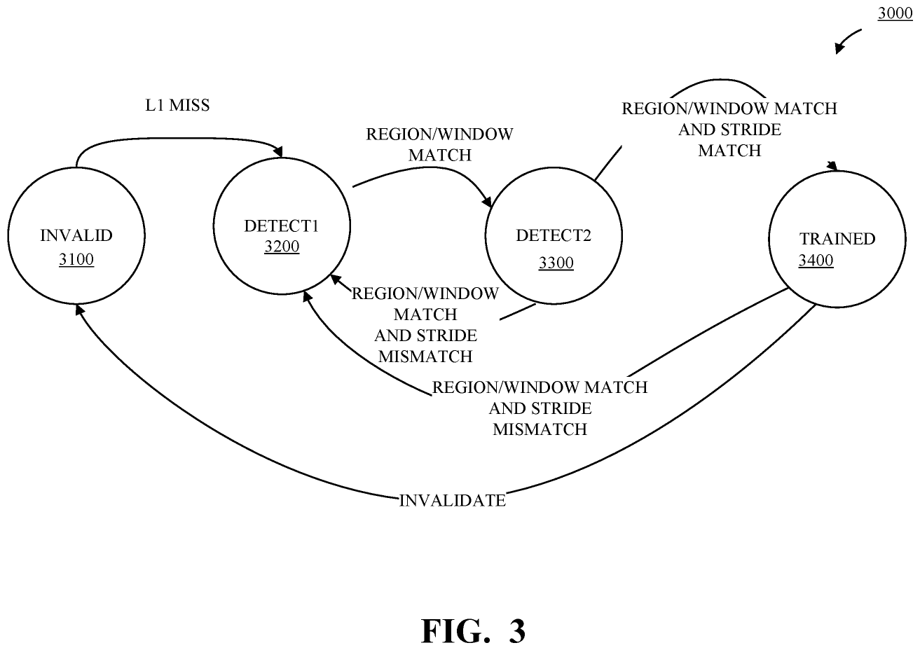

FIG. 3 is a diagram showing an example state machine 3000 for a hardware prefetcher. The state machine 3000 can include an invalid state 3100, a detect1 state 3200, a detect2 state 3300, and a trained state 3400. The hardware prefetcher can allocate an entry when a first demand load misses in a L1 data cache, for example. In this instance, it is assumed that the first demand load does not match an existing entry. Allocation of the entry can be based on a variety of policies. For example, the allocation policy can look for and allocate the lowest index invalid entry. If all entries are valid, then look for an untrained entry using a pseudo-least recently used (PLRU) algorithm. If all entries are valid and in a trained state, look for an entry using the PLRU algorithm. The window for the entry is set based on the first demand load. The state machine 3000 moves from the invalid state 3100 to the detect1 state 3200.

The hardware prefetcher determines whether a second demand load which missed in the L1 data cache falls in the window. If the second demand load falls within the window, a stride is determined from the address in the second demand load and the address in the first demand load. The state machine 3000 moves from the detect1 state 3200 to the detect2 state 3300. The window slides over such that the second demand load is the center of the window.

The hardware prefetcher determines whether a third demand load which missed in the L1 data cache falls in the window and matches the stride. If the third demand load falls within the window and matches the stride, the state machine 3000 moves from the detect2 state 3300 to the trained state 3400. The entry in the trained state is trained with respect to the L1 data cache and higher level caches in contrast to having to train the entry for each cache level. When the entry is in the trained state, the hardware prefetcher generates a programmable number of prefetches. If the programmable number of prefetches exceeds the maximum number of prefetches that can be sent as L1 prefetches (a programmable number), then L2 prefetches are sent once the L1 prefetches are sent. In the event that L1 MSHRs are full before completing the sending of the L1 prefetches, then L2 prefetches can be sent opportunistically. If the third demand load falls within the window and mismatches the stride, the state machine 3000 moves from the trained state 3400 to the detect1 state 3200. Again, the window slides over such that the third demand load is the center of the window.

During the trained state 3400, if a subsequent demand load which missed in the L1 data cache falls within the window and matches the stride, an additional one L1 prefetch and one L2 prefetch are sent out. In this instance, as the demand stream pointer moves, L1 and L2 prefetch pointers are also moved to maintain how far ahead each of the L1 and L2 prefetch pointers are from the demand stream. Consequently, one more L1 prefetch and one more L2 prefetch are sent.

During the trained state 3400, if the subsequent demand load which missed in the L1 data cache falls within the window and mismatches the stride, the state machine 3000 may move from the trained state 3400 to the detect1 state 3200 depending on how many stride mismatches can be forgiven (a programmable number) as described herein. That is, if forgiveness is enabled and still has credits for a trained entry, then the state machine 3000 will stay in the trained state 3400. During the trained state 3400, the state machine goes to the invalid state 3100 when the respective entry is invalidated due to cache feedback, for example, or the respective entry is evicted using a replacement policy. A round-robin pick policy can be used when multiple hardware prefetch entries are generating prefetches.

The state machine includes logic to track the interplay between L1 prefetches and L2 prefetches. This includes, but is not limited to, what was the last L1 prefetch sent, what was the last L2 prefetch sent, how many L1 prefetches have been sent, how many L2 prefetches have been sent, L1 prefetch-distance, L2 prefetch-distance, L1 MSHR fullness count, and L2 MSHR fullness count. The state machine can track and determine when to send L1 prefetches, L2 prefetches, switch between sending L1 prefetches and L2 prefetches, and pull cache lines from a L2 MSHR to the L1 MSHR.

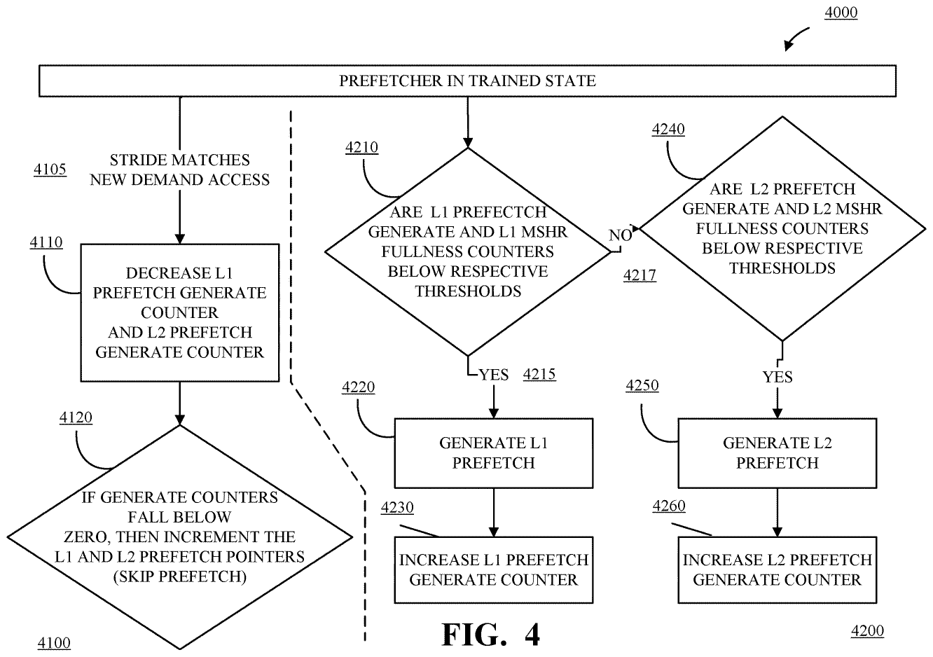

FIG. 4 is a flowchart of an example method 4000 for hardware prefetcher operation in the trained state. The method 4000 uses a L1 prefetch generate counter and a L2 prefetch generate counter to show how far ahead of the demand stream the respective prefetches are. The method 4000 uses a L1 prefetch generate threshold and a L2 prefetch generate threshold to determine how far ahead (i.e., prefetch-distance) the respective prefetches should be relative to the demand stream. The L1 prefetch generate threshold and a L2 prefetch generate threshold can have different values. The L1 prefetch generate threshold and a L2 prefetch generate threshold can change dynamically dependent on prefetcher aggressiveness by changing the prefetch-distance. The method 4000 uses a L1 fullness threshold and a L2 fullness threshold to determine whether there is available space in the respective MSHR. The method 4000 uses a L1 pointer and a L2 pointer to indicate the last respective prefetch address and can be incremented or decremented depending on stride.

The method 4000 includes a confirmation path 4100 and an arbitration path 4200. The confirmation path 4100 can confirm that a trained entry in the prefetcher is still valid based on demand request(s), such as demand load request(s), having stride matches. The arbitration path 4200 can determine whether to send a L1 prefetch or a L2 prefetch depending on the respective counters and thresholds. As described herein, the hardware prefetcher operates to increase the counts in the L1 prefetch generate counter and the L2 prefetch generate counter to reach the L1 prefetch generate threshold and the L2 prefetch generate threshold, respectively.

In the confirmation path 4100, the method 4000 includes decreasing the L1 prefetch generate counter and the L2 prefetch generate counter (4110) when a demand request matches a stride for the applicable trained entry (4105). The method 4000 includes incrementing (or decrementing depending on the implementation) a position of the L1 pointer and the L2 pointer if the L1 prefetch generate counter and the L2 prefetch generate counter fall below zero (4200). In this instance, the prefetch is skipped.

In the arbitration path 4200, the method 4000 includes determining if the L1 prefetch generate counter is below the L1 prefetch generate threshold and if the L1 MSHR fullness counter is below the L1 fullness threshold (4210). The method 4000 includes generating a L1 prefetch (4220) if the L1 prefetch generate counter is below the L1 prefetch generate threshold and if the L1 MSHR fullness counter is below the L1 fullness threshold (4215). The method 4000 includes increasing the L1 prefetch generate counter after generating the L1 prefetch (4230). The determination if the L2 prefetch generate counter is below the L2 prefetch generate threshold and if the L2 MSHR fullness counter is below the L2 fullness threshold (4240) is done if the L1 prefetch generate counter is equal to or above the L1 prefetch generate threshold or if the L1 MSHR fullness counter is equal to or above the L1 fullness threshold (4217). The method 4000 includes generating a L2 prefetch (4250) if the L2 prefetch generate counter is below the L2 prefetch generate threshold and if the L2 MSHR fullness counter is below the L2 fullness threshold (4215). The method 4000 includes increasing the L2 prefetch generate counter after generating the L2 prefetch (4260). In implementations, no prefetches are sent if the L2 prefetch generate counter is equal to or above the L2 prefetch generate threshold or if the L2 MSHR fullness counter is equal to or above the L2 fullness threshold. In implementations, a prefetch can be sent to higher level caches including L3 and above.

As noted, and described herein, the L1 MSHRs and L2 MSHRs vary in size and are configurable. Fullness or an indication of how many MSHRs have been allocated (or available) is provided as feedback by the MSHRs in the respective caches. In implementations, the fullness feedback can be provided by a N bit field, where a value indicates the fullness of the MSHR. For example, if N is a 4 bit field, then a value of 8 from the MSHR would indicate half-full (or empty). This value could then be compared against a configurable fullness threshold to determine whether additional prefetches can be sent. This allows the interface and values indications to stay the same even if the implementation configures a different number of MSHRs.

As noted, and described herein, the hardware prefetcher, including the state machine, can use different feedback mechanisms to tune which L1 MSHRs and L2 MSHRs to use, throttle sending of specific prefetches, and invalidating entries. This can be implemented using counters for the MSHR feedback and cache feedback, and configurable thresholds for each of the counters. For example, multiple features of the hardware prefetcher and the issue queue are configurable, including but not limited to, the number of prefetch streams that the hardware prefetcher can track, initial or default prefetch-distance, maximum allowed prefetch-distance, prefetch-distance aggressiveness thresholds, entry eviction thresholds, issue queue injection or priority request, threshold for directly sending prefetches to L2 instead of L1 MSHR, forgiveness threshold, fullness thresholds, number of dedicated L1 prefetch issue queue entries, number of dedicated L2 prefetch issue queue entries, and threshold hits in L2 cache tag to stop sending prefetches to L2.

In implementations, the hardware prefetcher can track (using a L1 data cache hit counter) the number of L1 prefetches and/or L2 prefetches that hit a L1 data cache tag (which is sent by the data cache as a type of cache feedback). If the L1 data cache hit counter exceeds a L1data cache hit threshold, the hardware prefetcher can stop sending L1 prefetches for an applicable trained entry or invalidate the applicable trained entry.

In implementations, the hardware prefetcher can track (a L2 cache hit counter) the number of L2 prefetches that hit a L2 cache tag established by a demand request (which is sent by the cache as a type of cache feedback). If the L2 cache hit counter exceeds a L2 data cache hit threshold, the hardware prefetcher can stop sending L2 prefetches for the trained entry. Although no L2 MSHRs are being used, the stoppage can save bandwidth and power. L1 prefetches for the trained entry are still sent to pull the L2 MSHRs into the L1 MSHRs when available.

In implementations, the aggressiveness of the hardware prefetcher can be dynamically adjusted based on counting the number of confirmations in the L1 or L2 MSHRs which is sent by the respective MSHRs as MSHR feedback. Confirmations occur when an MSHR is established by a prefetch and later a demand to the same cache line is observed or established by a demand and later a prefetch to the same cache line is observed. L1 MSHRs can be established by L1 prefetches which later have a matching demand or established by demand requests that later have a matching L1 prefetch. An L1 MSHR hit event is created when a respective count has reached a programmable threshold. L2 MSHRs can be established by L2 prefetches or by L1 prefetches which later have matching demand requests. An L2 MSHR hit event is created when a count has reached a programmable threshold. When either the L1 MSHR hit event or the L2 MSHR hit event occurs, the aggressiveness (number of prefetches to be sent) of the associated trained entry is increased by one. The process repeats until the aggressiveness reaches a threshold (programmable), beyond which for every such event, the aggressiveness of the respective entry is doubled.

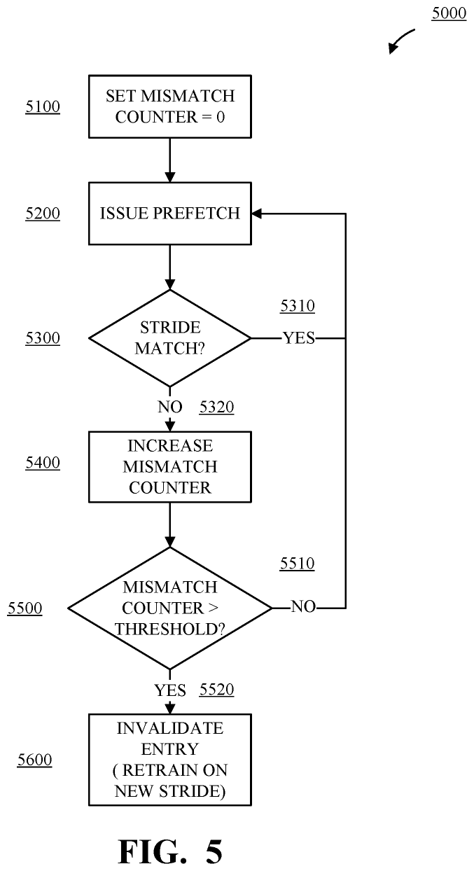

FIG. 5 is a flowchart of an example method 5000 for forgiveness for a trained entry in a hardware prefetcher. The method 5000 includes initializing a stride mismatch counter to zero for an entry in a trained state (5100). In implementations, a decrementing counter can be used. The method 5000 includes issuing a prefetch (5200). The method 5000 includes checking a demand request for a mismatch (5300). If the window and stride match (5310), the method 5000 continues issuing prefetches (5200). If the window or stride do not match (5320), the mismatch counter is incremented (or decremented depending on the implementation) (5400). The method 5000 includes checking if a forgiveness threshold has been exceeded (or is less than) (5500). If the mismatch counter has not exceeded (or not fallen below) the forgiveness threshold (5510), then continue issuing prefetches (5200). If the mismatch counter has been exceeded (or has fallen below) the forgiveness threshold (5520), then invalidate the entry (5600). In implementations, retraining can retrain the window, the stride, or both. In implementations, the state machine 3000 of FIG. 3 can go to the detect1 state 3200 to reduce the training time. The forgiveness threshold is a programmable or configurable threshold which can be set, for example, using a configuration status register.

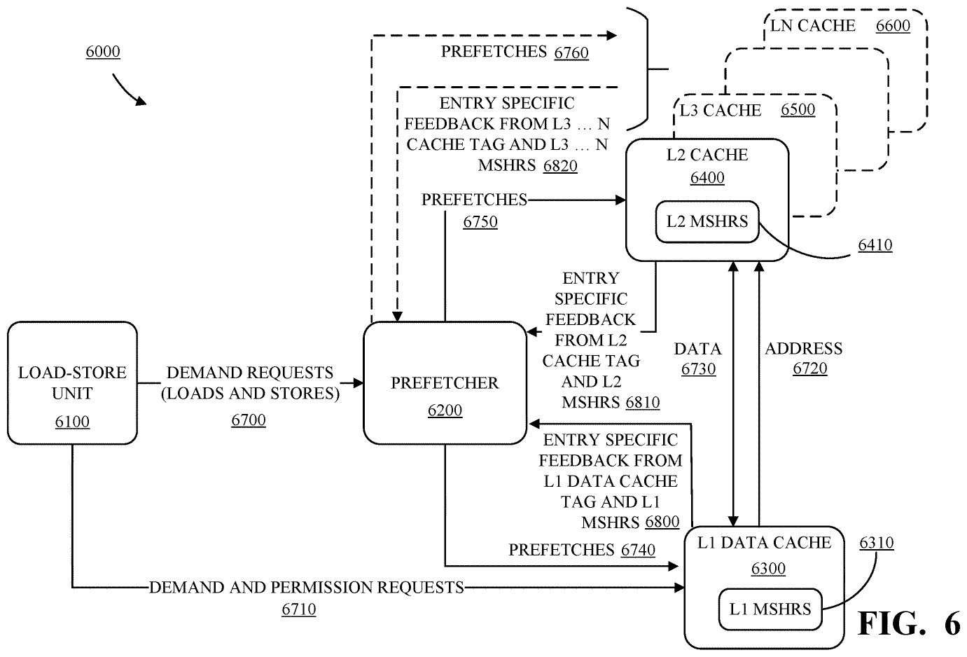

FIG. 6 is a block diagram showing an example of a processing system 6000. The processing system 6000 can be, for example, a core. The processing system 6000 includes a load-store unit 6100, a prefetcher 6200, an L1 data cache 6300, an L2 cache 6400, a L3 cache 6500, and higher level (LN) caches 6600. Each of the L1 data cache 6300, the L2 cache 6400, the L3 cache 6500, and the higher level (LN) cache(s) 6600 can include MSHRs. For example, the L1 data cache 6300 can include L1 MSHRs 6310 and the L2 cache 6400 can include L2 MSHRs 6410. The number of MSHRs in each cache can be different. In implementations, the number of L1 MSHRs is typically less than the number of L2 MSHRs and the number of L2 MSHRs is typically less than the number of L3 MSHRs. Other portions of the processing system 6000 are not shown in FIG. 6 for clarity. The processing system 6000 can implement the methods, the feedback mechanisms, and the hardware prefetchers described herein.

The load-store unit 6100 sends a demand request to the prefetcher 6200 (6700) and demand request and permissions to the L1 data cache 206 (6710), wherein permissions refers to read and write permissions with respect to the data. The L1 data cache 6300 looks for the requested data by checking if the address of the requested data is in the L1 data cache 6300. The L1 data cache 6300 may check its L1 MSHRs 6310 to determine whether an MSHR entry has been allocated for the requested address. The L1 MSHRs 6310 in the L1 data cache 6300 track what data is being requested from higher levels of memory. If a demand request from the load-store unit 6100 goes directly to the L1 data cache 6300 (i.e., 6710) and sees that an MSHR entry in the L1 MSHRs 6310 has been established because of a prefetch from the prefetcher 6200, that means that the prefetcher 6200 has done its job because it has technically hidden the cycles that passed between when the MSHR entry was established and when the demand request 6710 from the load-store unit 6100 arrived, so the processing system 6000 has saved a number of cycles.

The L1 MSHRs 6310 can send feedback 6800 to the prefetcher 6200 as positive reinforcement from the L1 MSHRs 6310. The feedback 6800 can be a confirmation as described herein. The positive reinforcement can result in increasing the prefetch-distance or increasing the aggressiveness of the prefetcher 6200. The MSHRs operate in a similar manner in the different levels of cache, e.g., the L2 cache 6400, the L3 cache 6500, and the LN cache 6600.

If there is an MSHR entry in the L1 MSHRs 6310 corresponding to the requested address, this means that there is a pending miss for the requested address in the L1 data cache 6300 and that the data is not in the L1 data cache 6300. If there is no MSHR entry in the L1 MSHRs 6310 corresponding to the requested address, and if a MSHR entry is available in the L1 MSHRs 6310, an MSHR entry is allocated for the requested address.

The L1 data cache 6300 then sends the requested address (6720) to the L2 cache 6400. If the requested address 6720 is found in the L2 cache 6400, the L2 cache 6400 returns data 6730 to the L1 data cache 6300 where the data can be accessed by the load-store unit 6100. The L2 cache 6400 looks for the requested data by checking if the address 6720 of the requested data is in the L2 cache 6400. The L2 cache 6400 may check the L2 MSHRs 6410 to determine whether an MSHR entry has been allocated for the requested address. If there is an MSHR entry in the L2 MSHRs 6410 corresponding to the requested address, this means that there is a pending miss for the requested address in the L2 cache 6400 and that the data is not in the L2 cache 6400. If there is no MSHR entry in the L2 cache 6400 corresponding to the requested address 6720, and if an MSHR entry is available in the L2 MSHRs 6410, an MSHR entry is allocated for the requested address 6720. The L2 cache 6400 then sends the requested address to the L3 cache 6500. If the requested address is found in the L3 cache 6500, the L3 cache 6500 returns data to the L2 cache 6400 where the data can be accessed by the load-store unit 6100 as described herein. The process moves onto LN cache 6600 as appropriate and applicable.

The prefetcher 6200 uses the demand request 6700 received from the load-store unit 6100 to train itself on a data access pattern based on multiple demand requests from the same data stream resulting in a trained entry. When there is an idle cycle available, the prefetcher 6200 sends prefetches to different cache levels based on the determined patterns for the individual data streams or trained entries. In an implementation, the prefetcher 6200 includes an arbiter to select a prefetch from each of the streams in a round-robin manner.

The prefetcher 6200 sends a prefetch 6740 to the L1 data cache 6300. If the L1 data cache 6300 has the data requested by the prefetch 6740, then the prefetch 6740 was not useful. The data is in the L1 data cache 6300 because another data request already requested the data. So the prefetch 6740 sent by the prefetcher 6200 is not useful, and any prefetcher pattern that has been latched onto should be disincentivized. The L1 data cache 6300 can send feedback 6800 to the prefetcher 6200 to indicate that the prefetch 6740 was not useful or as negative reinforcement, where negative reinforcement can result in moving towards invalidation or invalidation of the entry. For example, a L1 hit cache counter can be increased. This moves the L1 hit cache counter toward the L1 hit cache threshold, where reaching the L1 hit cache threshold would mean stop sending L1 prefetches.

If the L1 data cache 6300 does not have the data requested by the prefetch 6740, then the data is retrieved from higher levels of cache or from memory. In this instance, the prefetch 6740 is useful and the L1 data cache 6300 can send feedback 6800 to the prefetcher 6200 as positive reinforcement. In this instance, the feedback 6800 is used by the prefetcher 6200 to increase the number of prefetches sent from that entry, and the prefetcher 6200 has latched onto a good pattern. A goal is to incentivize this pattern, since the data is not in the L1 data cache 6300 (i.e., that the prefetch from the prefetcher 6200 was accurate and considered to be a “good” prefetch). For example, a L1 hit cache counter can be decreased. This moves the L1 hit cache counter further away from reaching a L1 hit cache threshold, where reaching the L1 hit cache threshold would mean stop sending L1 prefetches.

The prefetcher 6200 sends a prefetch 6750 to the L2 cache 6400. If the L2 cache 6400 has the data requested by the prefetch 6750, then the prefetch 6750 was not useful. The data is in the L2 cache 6400 because another demand request already requested the data. So the prefetch 6750 sent by the prefetcher 6200 is not useful, and any prefetcher pattern that has been latched onto should be disincentivized. The L2 cache 6400 can send feedback 6810 to the prefetcher 6200 to indicate that the prefetch 6750 was not useful or as negative reinforcement. For example, a L2 hit cache counter can be increased. This moves the L2 hit cache counter toward the L2 hit cache threshold, where reaching the L2 hit cache threshold would mean stop sending L2 prefetches.

If the L2 cache 6400 does not have the data requested by the prefetch 6750, then the data is retrieved from higher levels of cache or from memory. In this instance, the prefetch 6750 is useful and the L2 cache 6400 can send feedback 6810 to the prefetcher 6200 as positive reinforcement. In this instance, the feedback 6810 is used by the prefetcher 6200 to increase the number of prefetches sent from that entry, and the prefetcher 6200 has latched onto a good pattern. A goal is to incentivize this pattern since the data is not in the L2 cache 6400. For example, a L2 hit cache counter can be decreased. This moves the L2 hit cache counter further away from reaching a L2 hit cache threshold, where reaching the L2 hit cache threshold would mean stop sending L2 prefetches.

The prefetcher 6200 sends a prefetch 6760 to the L3 cache 6500, . . . , LN cache 6600 as appropriate and applicable (appropriate cache level). If the appropriate cache level has the data requested by the prefetch 6760, then the prefetch 6760 was not useful. The data is in the appropriate cache level because another demand request already requested the data. So the prefetch 6760 sent by the prefetcher 6200 is not useful, and any prefetcher pattern that has been latched onto should be disincentivized. The appropriate cache level can send feedback 6820 to the prefetcher 6200 to indicate that the prefetch 6760 was not useful or as negative reinforcement. For example, an appropriate hit cache counter can be increased. This moves the appropriate hit cache counter toward the appropriate hit cache threshold, where reaching the appropriate hit cache threshold would mean stop sending appropriate cache level prefetches.

If the appropriate cache level does not have the data requested by the prefetch 6760, then the data is retrieved from higher levels of cache or from memory. In this instance, the prefetch 6760 is useful and the appropriate cache level can send feedback 6820 to the prefetcher 6200 as positive reinforcement. In this instance, the feedback 6820 is used by the prefetcher 6200 to increase the number of prefetches sent from that entry, and the prefetcher 6200 has latched onto a good pattern. A goal is to incentivize this pattern since the data is not in the appropriate cache level. For example, an appropriate hit cache counter can be decreased. This moves the appropriate hit cache counter further away from reaching an appropriate hit cache threshold, where reaching the appropriate hit cache threshold would mean stop sending appropriate cache level prefetches.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

The term “circuit” refers to an arrangement of electronic components (e.g., transistors, resistors, capacitors, and/or inductors) that is structured to implement one or more functions. For example, a circuit may include one or more transistors interconnected to form logic gates that collectively implement a logical function. For example, the processor can be a circuit.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices and methods shown and described herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

It is to be understood that the figures and descriptions of embodiments have been simplified to illustrate elements that are relevant for a clear understanding, while eliminating, for the purpose of clarity, many other elements found in typical processors. Those of ordinary skill in the art may recognize that other elements and/or steps are desirable and/or required in implementing the present disclosure. However, because such elements and steps do not facilitate a better understanding of the present disclosure, a discussion of such elements and steps is not provided herein.

Although some embodiments herein refer to methods, it will be appreciated by one skilled in the art that they may also be embodied as a system or computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A processing system, comprising:
two or more cache levels, each cache level including miss status holding registers; and
a prefetcher connected to each of the two or more cache levels, the prefetcher configured to:
receive feedback from the miss status holding registers at each cache level for previously sent prefetches; and
control number of prefetches sent for a trained entry to each cache level of the two or more cache levels based on the feedback.

2. The processing system of claim 1, wherein the feedback includes a fullness indicator of the miss status holding registers at each cache level, the prefetcher configured to:
send prefetches to cache levels of the two or more cache levels which have available miss status holding registers.

3. The processing system of claim 2, wherein the fullness indicator is a relative indicator allowing the prefetcher to be uninformed of an absolute size of the miss status holding registers at each cache level.

4. The processing system of any of claims 1-3, wherein the feedback includes a confirmation for the trained entry, the confirmation indicating that a demand load address matches a pending prefetch address, the prefetcher configured to:
send a prefetch for the trained entry to a first cache level of the two or more cache levels; and
send another prefetch for the trained entry to at least a second cache level of the two or more cache levels.

5. The processing system of any of claims 1-4, wherein the feedback includes a confirmation for the trained entry, the confirmation indicating that the trained entry is prefetching in a proper direction, the prefetcher configured to:
send a prefetch for the trained entry to a first cache level of the two or more cache levels; and
send another prefetch for the trained entry to at least a second cache level of the two or more cache levels.

6. The processing system of any of claims 1-5, further including a prefetch issue queue, the prefetch issue queue enabling the prefetcher to replay a prefetch if miss status holding registers are exhausted, miss in the page table cache, miss in view of a resource check, or miss in view of a hazard check prior to completion of sending the prefetch.

7. The processing system of claim 6, wherein the prefetcher can replay the prefetch by converting on-the-fly the prefetch from one cache level to another cache level.

8. The processing system of claim 6, wherein the prefetcher can replay the prefetch by replaying the prefetch from the prefetch issue queue.

9. The processing system of claim 6, wherein the prefetch issue queue includes dedicated prefetch slots for each cache level.

10. The processing system of any of claims 1-9, wherein the prefetcher comprises:
a state machine configured to establish trained entries in the prefetcher, each entry having a base address and a stride; and
a forgiveness counter to track number of stride mismatches resulting from demand requests,
wherein the state machine is configured to control moving from a trained state to a non-trained state for a trained entry when the forgiveness counter exceeds a stride mismatch threshold.

11. The processing system of any of claims 1-10, wherein the prefetcher comprises:
a cache hit counter for each cache level, each cache hit counter tracks number of prefetches sent for a trained entry that hit a cache tag established by a demand request,
wherein the prefetcher is configured to stop sending prefetches for the trained entry when the cache hit counter exceeds a cache hit threshold for the associated cache level.

12. The processing system of any of claims 1-11, wherein the prefetcher comprises:
a cache hit counter for each cache level, each cache hit counter tracks number of prefetches sent for a trained entry that hit a cache tag established by a demand request,
wherein the prefetcher is configured to invalidate the trained entry for an associated cache level when the cache hit counter exceeds a cache hit threshold for the associated cache level.

13. The processing system of any of claims 1-12, wherein the prefetcher comprises:
a first cache level miss status holding registers confirmation or hit-counter for a first cache level, the first cache level miss status holding registers confirmation or hit-counter counts number of demand requests for a trained entry that hit a miss status holding register entry established by first cache level prefetches or counts number of first cache level prefetch requests for a trained entry that hit a miss status holding register entry established by a demand, wherein a first cache level miss status holding registers hit event is generated when the first cache level miss status holding registers confirmation or hit-counter exceeds a first cache level miss status holding registers hit threshold; and
a higher cache level miss status holding registers hit-counter for each higher cache level, each higher cache level miss status holding registers hit-counter counts number of hits by the first cache level prefetches that hit a higher cache level miss status holding registers entry established by higher level prefetches or higher level prefetch that hit a an entry established by a lower cache level prefetches, wherein a higher cache level miss status holding registers hit event is generated when the higher cache level miss status holding registers hit-counter exceeds a higher cache level miss status holding registers hit threshold,
wherein an aggressiveness of the prefetcher is increased upon occurrence of either the first cache level miss status holding registers hit event or the higher cache level miss status holding registers hit event.

14. A method for sending prefetches, the method comprising:
receiving, by a prefetcher from miss status holding registers at each cache level of a multi-cache level hierarchy, feedback for previously sent prefetches; and
controlling, by the prefetcher, number of prefetches sent for a trained entry to two or more cache levels in the multi-cache level hierarchy based on the feedback.

15. The method of claim 14, wherein the feedback includes a fullness indicator of the miss status holding registers at each cache level, and wherein the fullness indicator is a relative indicator allowing the prefetcher to be uninformed of an absolute size of the miss status holding registers at each cache level, the sending further comprising:
sending prefetches to cache levels of the multi-cache level hierarchy which have available miss status holding registers.

16. The method of any of claims 14-15, wherein the feedback includes a confirmation for the trained entry, the confirmation indicating that a demand load address matches a pending prefetch address, the method further comprising:
sending a prefetch for the trained entry to a first cache level of the multi-cache level hierarchy; and
sending another prefetch for the trained entry to at least a second cache level of the multi-cache level hierarchy.

17. The method of any of claims 14-16, further comprising:
establishing, by a state machine in the prefetcher, trained entries, each entry having a base address and a stride;
counting, by a forgiveness counter in the prefetcher, number of stride mismatches resulting from demand requests for a trained entry; and
moving from a trained state to a non-trained state for the trained entry when the forgiveness counter exceeds a stride mismatch threshold.

18. A prefetcher, comprising:
one or more trained entries for each cache in at least a two-level cache hierarchy, the prefetcher configured to:
receive feedback, from miss status holding registers at each cache of the at least two-level cache hierarchy, for previously sent prefetches; and
control sending, to two or more caches in the at least two-level cache hierarchy, prefetches for a trained entry based on the feedback.

19. The prefetcher of claim 18, wherein the feedback includes a fullness indicator of the miss status holding registers at each cache level, and wherein the fullness indicator is a relative indicator allowing the prefetcher to be uninformed of an absolute size of the miss status holding registers at each cache level of the at least a two-level cache hierarchy, the prefetcher further configured to:
send prefetches to cache levels of the at least a two-level cache hierarchy which have available miss status holding registers.

20. The prefetcher of any of claims 18-19, wherein the feedback includes a confirmation for the trained entry, the confirmation indicating that a demand load address matches a pending prefetch address, the prefetcher further configured to:
send a prefetch for the trained entry to a first cache level of the at least a two-level cache hierarchy; and
send another prefetch for the trained entry to at least a second cache level of at least a two-level cache hierarchy.
